(19) United States
(12) Patent Application Publication
(10) Pub. No.: US 2026/0003553 A1
(43) Pub. Date: Jan. 1, 2026

(54) INFORMATION PROCESSING APPARATUS, STORAGE MEDIUM, AND METHOD

(71) Applicant: CANON KABUSHIKI KAISHA, Tokyo (JP)

(72) Inventor: TAKESHI HAYAKAWA, Kanagawa (JP)

(21) Appl. No.: 19/253,365

(22) Filed: Jun. 27, 2025

(30) Foreign Application Priority Data
Jul. 1, 2024 (JP) 2024-106232

(51) Int. Cl. G06F 3/12

(52) U.S. Cl. CPC G06F 3/1254; G06F 3/1205; G06F 3/1284

(57) ABSTRACT

A method for an information processing apparatus that displays a screen includes receiving a non-standard size setting as a paper size of a printing setting on the screen, automatically changing a setting of a paper feed unit to manual feed based on receipt of a non-standard size setting without receiving a user operation for changing the setting of the paper feed unit on the screen, and controlling transmission of a print job based on the print setting to an image processing apparatus.

### BACKGROUND

### Field of the Technology

The present disclosure relates to an information processing apparatus, a storage medium, and a method.

### Description of the Related Art

In recent years, with the widespread use of devices, more companies have started incorporating devices in their business operations. A terminal on which an application for instructing an image processing apparatus, such as a multifunction peripheral and a printer, to execute processing has been installed may issue an instruction to perform printing or scanning to the image processing apparatus. For example, a user selects a file in a folder, performs a print setting on an application of a mobile terminal, and transmits an instruction to execute printing to an image processing apparatus. The image processing apparatus that receives the execution instruction executes print processing based on the setting.

Japanese Patent Application Laid-Open No. 2018-173995 discusses a technique in which a terminal generates print data including information specifying a paper feed port and transmits the print data to an image processing apparatus.

In a case where an instruction to perform printing is issued from an information processing apparatus to an image processing apparatus, it is troublesome for a user to set a paper feed port, a paper size, or the like on the terminal, and an inexperienced user may be unable to appropriately perform such setting.

### SUMMARY

The present disclosure is directed to providing of a method for enabling a suitable print setting in a case where a print job is transmitted from an information processing apparatus to an image processing apparatus.

According to an aspect of the present disclosure, a method for controlling an information processing apparatus including a predetermined program, the method includes receiving a non-standard size setting as a paper size of a print setting on a screen that is displayed by the predetermined program, automatically changing a setting of a paper feed unit to manual feed by the predetermined program based on receipt of the non-standard size setting without receiving a user operation for changing the setting of the paper feed unit in the print setting on a screen that is displayed by the predetermined program, and controlling transmission of a print job based on the print setting to an image processing apparatus by the predetermined program.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram illustrating an example of a configuration of a communication system.

FIG. 2 is a diagram illustrating a software configuration of an information processing apparatus.

FIGS. 3A and 3B are diagrams each illustrating an example of a user interface (UI) of a communication application.

FIGS. 4A to 4D are diagrams each illustrating an example of a UI relating to printing of the communication application.

FIG. 5 is a flowchart illustrating an example of selecting a paper feed unit.

FIG. 6 is a diagram illustrating an example of a UI relating to print settings of the communication application.

FIG. 7 is a flowchart illustrating an example of changing a print setting.

FIGS. 8A and 8B are diagrams each illustrating examples of UIs relating to print settings of the communication application.

FIG. 9 is a flowchart illustrating an example of changing a print preview screen.

FIGS. 10A and 10B are diagrams each illustrating an example of a UI relating to a print preview of the communication application.

FIGS. 11A and 11B are diagrams each illustrating an example of a UI relating to a printing method of the communication application.

FIG. 12 is a flowchart illustrating an example of processing based on each printing methods that is performed when user set paper is selected.

FIGS. 13A and 13B are diagrams each illustrating an example of a UI relating to paper sizes of the communication application.

### DESCRIPTION OF THE EMBODIMENTS

The embodiments will be described in detail below with reference to the accompanying drawings. The following embodiments are not intended to limit the disclosure. While multiple features are described in the embodiments, not all of these features are essential to the disclosure, and the features may be arbitrarily combined. In the accompanying drawings, the same or similar components are denoted by the same reference numerals, and the redundant descriptions are omitted.

The present disclosure includes modifications and improvements made to the embodiments described below, based on the ordinary knowledge of those skilled in the art, without departing from the spirit of the present disclosure.

An information processing apparatus and a communication apparatus included in a communication system according to a first exemplary embodiment are described. According to the present embodiment, a smartphone is described as an example of an information processing apparatus, but the present disclosure is not limited to this and can be applied to various devices, such as a mobile terminal, a notebook personal computer (PC), a tablet terminal, a personal digital assistant (PDA), and a digital camera. The present disclosure can be applied to various apparatuses that may perform wireless communication with information processing apparatuses as communication apparatuses. For example, the present disclosure can be applied to any printer, such as an ink-jet printer and an electrophotographic printer, where the printer is an image processing apparatus. The present disclosure can also be applied to a scanner, a copying machine, a facsimile (FAX) machine, a mobile terminal, a smartphone, a notebook PC, a tablet terminal, a PDA, a digital camera, a music reproduction device, a television, a smart speaker, and the like. The present disclosure can also be applied to a multifunction peripheral that has a plurality of functions, such as a copy function, a FAX function, a print function, and a scanner function. According to the present embodiment, a communication apparatus is a multifunction printer that has a print function, a scanner function, and the like.

### Hardware Configuration of Each Apparatus

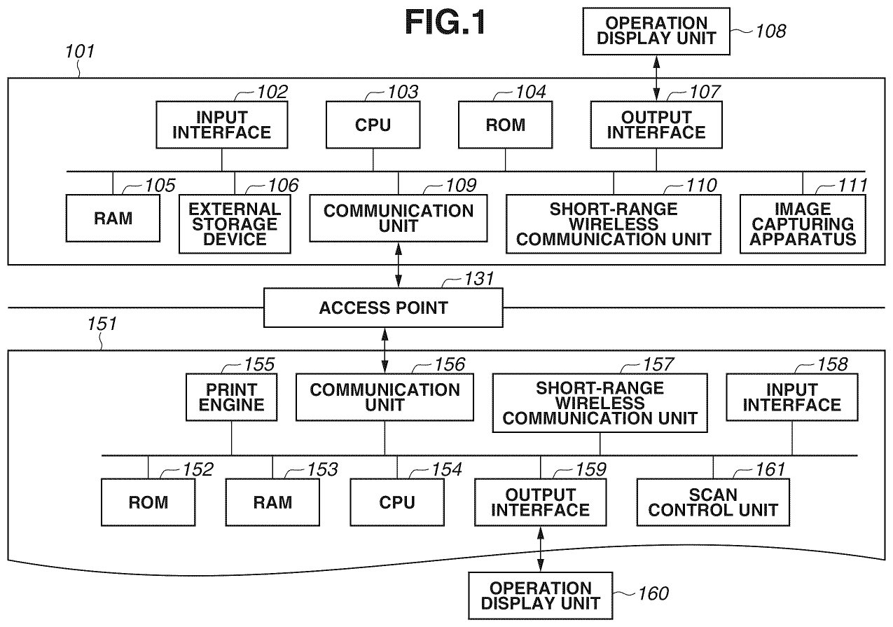

First, configurations of the information processing apparatus and the communication apparatus that can communicate with the information processing apparatus, both included in the communication system according to the present embodiment, are described with reference to a block diagram in FIG. 1. While, according to the present embodiment, the following configuration is described as an example, functions are not particularly limited to those illustrated in the Fig, 1.

An information processing apparatus 101 includes an input interface 102, a central processing unit (CPU) 103, a read-only memory (ROM) 104, a random access memory (RAM) 105, an external storage device 106, an output interface 107, an operation display unit 108, a communication unit 109, a short-range wireless communication unit 110, and an image capturing apparatus 111.

The input interface 102 receives a data input and an operation instruction from a user and is configured with a physical keyboard, a button, a touch panel, and the like. The output interface 107 described below and the input interface 102 may have the same configuration so that a screen output and reception of an operation from the user are performed by the same configuration.

The CPU 103 is a system control unit and controls the operation of the information processing apparatus 101.

The ROM 104 stores fixed data, such as a control program executed by the CPU 103, a data table, and an embedded operating system (hereinbelow, referred to as OS) program. According to the present embodiment, each control program stored in the ROM 104 performs software execution control, such as scheduling, task switching, and interrupt processing, under management of the embedded OS stored in the ROM 104. In the present embodiment, examples of the OS stored in the ROM 104 and operating on the information processing apparatus 101 are an Android® OS provided by Google, Inc., a Chrome® OS provided by Google, Inc., or iOS® provided by Apple, Inc. In a case where the OS operating on the information processing apparatus 101 is the Chrome® OS, the ROM 104 also includes a virtual Android® OS to operate an application for the Android® OS, which is described below, on the information processing apparatus 101.

The RAM 105 is configured with a static RAM (SRAM) or the like that requires a backup power supply. The RAM 105 retains data by using a primary battery (not illustrated) for data backup and may store important data, such a program control variable without volatilization. The RAM 105 also includes a memory area to store setting information and management data of the information processing apparatus 101 and the like. The RAM 105 is also used as a main memory and a work memory of the CPU 103.

The external storage device 106 includes an application program (hereinbelow, referred to as a communication application) that has a function of communicating with a communication apparatus 151. The communication application is specifically, for example, an application that has a print function of causing the communication apparatus 151 to execute printing and a scan function of causing the communication apparatus 151 to execute scanning. The present disclosure is not limited to this, and an application having either a print function or a scan function or an application having other functions may be used. The external storage device 106 includes various programs, such as a print information generation program that generates print information interpretable by the communication apparatus 151, and an information transmission/reception control program that performs transmission and reception with the communication apparatus 151 connected via the communication unit 109.

The external storage device 106 stores various information that is used by the above-described programs. The external storage device 106 also stores image data acquired from another information processing apparatus or the Internet via the communication unit 109.

The output interface 107 is an interface for the operation display unit 108 to perform control to display data and notify a user of a state of the information processing apparatus 101.

The operation display unit 108 is configured with a light-emitting diode (LED), a liquid crystal display (LCD), and the like, and displays data and notifies the user of the state of the information processing apparatus 101. A soft keyboard equipped with keys, such as a numerical value input key, a mode setting key, a determination key, a cancel key, and a power supply key, may be installed in the operation display unit 108 to receive an input from the user via the operation display unit 108.

The communication unit 109 is connected to an apparatus, such as the communication apparatus 151, and executes data communication. For example, the communication unit 109 is connectable to an access point (not illustrated) in the communication apparatus 151. The communication unit 109 is connected to the access point in the communication apparatus 151, whereby the information processing apparatus 101 and the communication apparatus 151 may communicate with each other. In the following description, an access point may also be referred to as an AP. The communication unit 109 may directly communicate with the communication apparatus 151 by wireless communication or may communicate with the communication apparatus 151 via an access point 131 that exists external to the information processing apparatus 101 and external to the communication apparatus 151. In the present embodiment, the Institute of Electrical and Electronics Engineers (IEEE) 802.11 series communication standard is used for a wireless communication method. The IEEE 802.11 series communication standard is Wireless Fidelity (Wi-Fi®).

The access point 131 may be a device, such as a wireless local area network (LAN) router, for example. According to the present embodiment, a method in which the information processing apparatus 101 and the communication apparatus 151 are directly connected to each other without using an external access point is referred to as a direct connection method. A method in which the information processing apparatus 101 and the communication apparatus 151 are connected to each other via the externally provided access point 131 is referred to as an infrastructure connection method.

The short-range wireless communication unit 110 wirelessly connects to an apparatus, such as the communication apparatus 151, at a short range to execute data communication and performs communication using a communication method different from a communication method that is used by the communication unit 109. The short-range wireless communication unit 110 uses a short-range wireless communication method, such as Bluetooth® and near field communication (NFC). Bluetooth® may be Bluetooth® Classic or Bluetooth® Low Energy. The short-range wireless communication unit 110 may be connected to a short-range wireless communication unit 157 in the communication apparatus 151.

The image capturing apparatus 111 converts an image captured using an imaging element into digital data. The digital data is temporarily stored in the RAM 105. The digital data is then converted into a predetermined image format by a program executed by the CPU 103 and stored as image data in the external storage device 106.

The communication apparatus 151 includes a ROM 152, a RAM 153, a CPU 154, a print engine 155, a communication unit 156, the short-range wireless communication unit 157, an input interface 158, an output interface 159, an operation display unit 160, and a scan control unit 161. In a case where a connection mode (communication mode) is set, the communication apparatus 151 is operable in the set connection mode.

The ROM 152 stores fixed data, such as a control program that is executed by the CPU 154, a data table, and an OS program.

The communication unit 156 enables the communication apparatus 151 to communicate with another apparatus. According to the present embodiment, the communication unit 156 performs communication according to the IEEE 802.11 series communication standard. The communication unit 156 includes an access point for connecting to an apparatus, such as the information processing apparatus 101, as an access point inside the communication apparatus 151. The access point may be connected to the communication unit 109 of the information processing apparatus 101. The communication unit 156 may directly communicate with the information processing apparatus 101 by wireless communication or may communicate with the information processing apparatus 101 via the access point 131. The communication unit 156 may include hardware that functions as an access point or may operate as an access point using software for causing the communication unit 156 to function as an access point. In the present embodiment, the communication unit 156 and the short-range wireless communication unit 157 are realized by a single wireless chip. In other words, in the present embodiment, a combination chip is used that supports both a communication function of the IEEE 802.11 series communication standard and a communication function of the short-range wireless communication method. The present disclosure is not limited to this configuration, and the communication unit 156 and the short-range wireless communication unit 157 may each be realized by a separate wireless chip.

The RAM 153 is configured with a dynamic RAM (DRAM) or the like that requires a backup power supply. The RAM 153 retains data by being supplied with a power supply (not illustrated) for data backup and thus, is able to store important data, such a program control variable, without volatilization. The RAM 153 is also used as a main memory and a work memory of the CPU 154 and stores a reception buffer for temporarily storing print information received from the information processing apparatus 101 or the like and various information.

In the present embodiment, each control program stored in the ROM 152 performs software execution control, such as scheduling, task switching, and interrupt processing under management of the embedded OS stored in the ROM 152. The ROM 152 also includes a memory area for storing data that needs to be retained even when power is not supplied, such as setting information and management data of the communication apparatus 151.

The CPU 154 is a system control unit and controls the operation of the communication apparatus 151.

The print engine 155 forms an image on a recording medium, such as paper, using a printing material, such as ink, based on information stored in the RAM 153 and a print job received from the information processing apparatus 101 or the like, and outputs a print result. In this processing, the print job transmitted from the information processing apparatus 101 or the like has a large amount of transmission data and requires high-speed communication. Thus, the print job is received via the communication unit 156 that may perform communication faster than the short-range wireless communication unit 157.

The short-range wireless communication unit 157 wirelessly connects to an apparatus, such as the information processing apparatus 101, at a short range to execute data communication and performs communication using a communication method different from the communication method used by the communication unit 156. The short-range wireless communication unit 157 uses the short-range wireless communication method, such as Bluetooth® and NFC. Bluetooth® may be Bluetooth® Classic or Bluetooth® Low Energy. The short-range wireless communication unit 157 may be connected to the short-range wireless communication unit 110.

The input interface 158 receives a data input and an operation instruction from a user and is configured with a physical keyboard, a button, a touch panel, and the like. The output interface 159 described below and the input interface 158 may have the same configuration so that a screen output and reception of an operation from the user are performed by the same configuration. The output interface 159 is an interface that is for the operation display unit 160 to perform control to display data and to notify the user of a state of the communication apparatus 151.

The operation display unit 160 is configured with an LED, an LCD, and the like, and displays data and notifies the user of the state of the communication apparatus 151. A soft keyboard equipped with keys, such as a numerical value input key, a mode setting key, a determination key, a cancel key, and a power supply key may be installed in the operation display unit 160 to receive an input from the user via the operation display unit 160.

The scan control unit 161 includes an image sensor unit (reading unit) that executes scanning of a document placed on a document platen or an automatic document feeder (ADF), which are not illustrated. The image sensor unit includes a light source that irradiates a document with light and an image sensor in which elements that read the reflected light and perform photoelectric conversion are arranged. The scan control unit 161 acquires image data by performing analog/digital (A/D) conversion on an analog electrical signal acquired by reading the document using the image sensor unit. The scan control unit 161 also includes a circuit that performs direct memory access (DMA) transfer to store the acquired image data in the RAM 153.

In a software AP mode, between devices communicating with each other (for example, the information processing apparatus 101 and the communication apparatus 151), one device (for example, the information processing apparatus 101) serves as a client that requests various services. The other device realizes a function of a Wi-Fi® access point by a software setting. The software AP corresponds to a master station (a parent station) of Wi-Fi®, and the client corresponds to a slave station (a child station) of Wi-Fi®. In the software AP mode, the client uses device search information to search for a device that becomes the software AP. In a case where the software AP is detected, the client and the software AP perform remaining wireless connection processing (such as establishing the wireless connection) therebetween, and subsequently perform Internet Protocol (IP) connection processing (such as assigning an IP address). A command and a parameter transmitted and received in a case where the wireless connection is realized between the client and the software AP may be those specified in the Wi-Fi® standard, and thus, a description thereof is omitted herein. The communication apparatus 151 itself operates as the software AP and thus may directly execute wireless communication with the information processing apparatus 101 without an external access point.

### Configuration of Communication Application

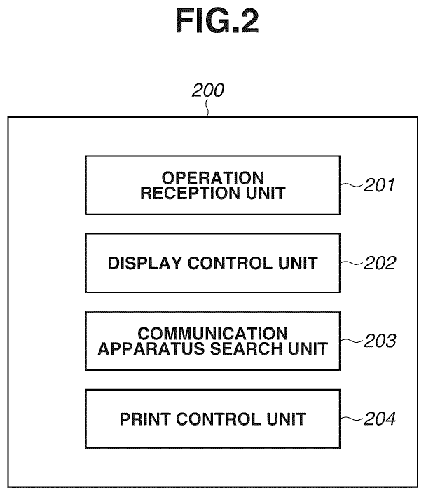

FIG. 2 is a diagram illustrating a configuration of a communication application 200 stored in the ROM 104, the external storage device 106, and the like of the information processing apparatus 101.

The communication application 200 is an application program that has a print function of causing the communication apparatus 151 functioning as a printer or a printing apparatus to print image data, document data, and the like stored in the information processing apparatus 101. The communication application 200 also has a function of acquiring image data, document data, and the like scanned by the communication apparatus 151 and storing them in the information processing apparatus 101.

A communication application 200 includes an operation reception unit 201, a display control unit 202, a communication apparatus search unit 203, and a print control unit 204. Each program unit is executed by the CPU 103 to realize the function provided by each unit. In the present embodiment, the communication application 200 receives an operation performed on the operation display unit 108 via the operation reception unit 201.

The display control unit 202 controls display on the operation display unit 108 by the communication application 200. For example, a list of searched printers (the communication apparatus 151) is displayed on the operation display unit 108 of the information processing apparatus 101.

The communication apparatus search unit 203 searches for a printer (the communication apparatus 151) that is able to be connected to the information processing apparatus 101 and is usable by the communication application 200.

The print control unit 204 transmits selected print target data to the communication apparatus 151, which has been selected, to print the print target data. The print target data may be, for example, document data, image data, and the like that are stored at the time when the communication application 200 is started. Alternatively, the print target data may be data acquired from a cloud server, the communication apparatus 151, or the like. The print target data may be data acquired from a different data source. In the following description, processing described as processing that is executed by the configuration in the communication application 200 is processing realized by the CPU 103 reading the communication application 200 stored in the ROM 104 or the like into the RAM 105 and executing it. For printing, the print control unit 204 generates a print job and transmits the generated print job to the communication apparatus 151 (i.e., a printer). The communication apparatus 151 executes the received print job, whereby printing is performed.

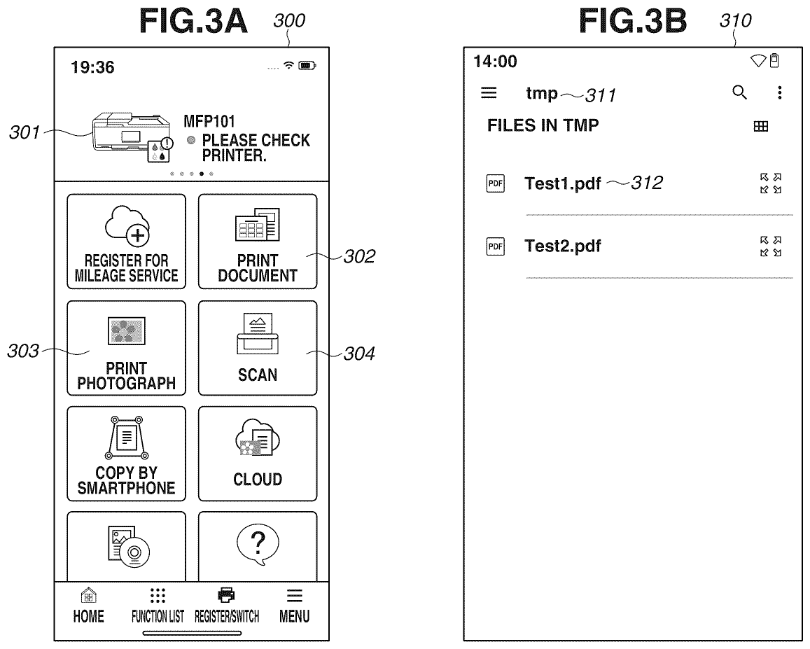

FIGS. 3A and 3B are diagrams each illustrating an example of a screen displayed by the communication application 200. A home screen 300 is displayed on the operation display unit 108 of the information processing apparatus 101. The home screen 300 is displayed at a time of starting the communication application 200 and is a screen on which a user selects a function to be executed from among the functions of the communication application 200. A target printer 301 of the communication application 200 is indicated. A multifunction peripheral (MFP) as the target printer 301 indicated in the home screen 300 is, for example, the communication apparatus 151 and is a target of a print instruction and a scan instruction from the communication application 200. The target printer is set from among the apparatuses searched by search processing. In response to selection of a document print button 302, the screen is shifted to a screen 310 illustrated in FIG. 3B. A photographic print button 303 is used to print a photograph. In response to selection of the photographic print button 303, the screen is shifted to a screen on which a photograph file is selected. A scan button 304 is used to instruct the communication apparatus 151 to perform scanning. In response to selection of the scan button 304, the screen is shifted to a scan setting screen.

A display item 311 in FIG. 3B is used to select data to be printed and indicates a folder hierarchy of data to be selected. The user changes a folder to be displayed by operating the display item 311. Data 312 indicates that the data is in the folder hierarchy indicated by the display item 311 and is Test1.pdf.

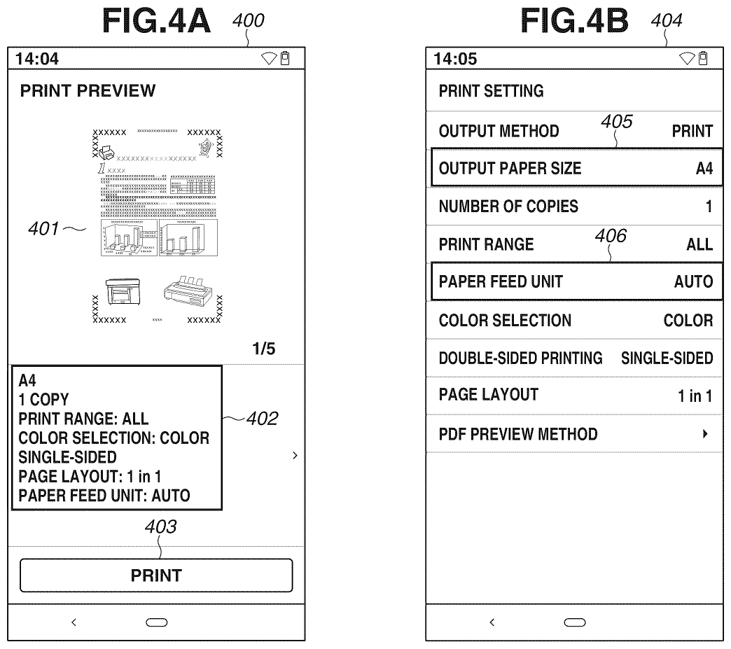

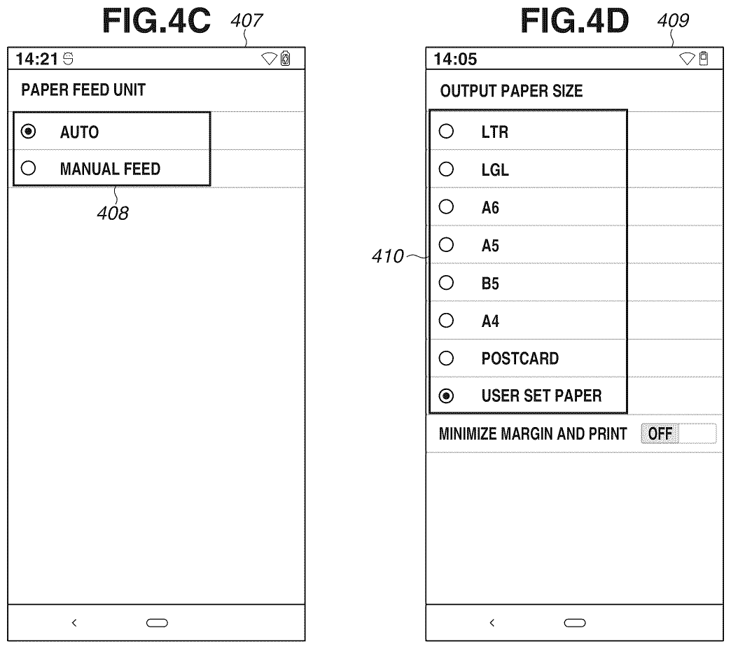

FIGS. 4A to 4D are diagrams each illustrating a display example of print settings of the communication application 200. In response to selection of the data 312 illustrated in FIG. 3B, the screen is shifted to a print preview screen 400. A print preview image 401 of data to be printed displays a preview of Test1.pdf of the data 312. A print button 403 is used to execute printing. In response to selection of the print button 403, the communication application 200 generates a print job and instructs the printer to print the print job. A print setting value list 402 displays current print settings. In response to selection of the print setting value list 402, the screen is shifted to a print setting screen 404.

Various print settings may be performed on the print setting screen 404. The print settings include an output paper size item 405. In response to selection of the output paper size item 405, the screen is shifted to an output paper size selection screen 409. The print settings include a paper feed unit item 406. In response to selection of the paper feed unit item 406, the screen is shifted to a paper feed unit selection screen 407. The paper feed unit selection screen 407 displays the paper feed unit that is selectable in the target printer 301. The user can select either automatic or manual feed in paper feed unit options 408. In a case where the user selects automatic, the target printer (the communication apparatus 151) feeds paper from an appropriate cassette. In a case where the user selects manual feed, the target printer (the communication apparatus 151) feeds paper from a manual feed tray. In response to the user selecting an item of automatic or manual feed in the paper feed unit options 408, the screen is shifted, and the print setting screen 404 in which the setting value selected in the paper feed unit options 408 is reflected is displayed.

The output paper size selection screen 409 displays the paper size selectable in the target printer 301. According to the present embodiment, paper size options 410 display enables selection of a non-standard paper size, such as user set paper, in addition to standard paper sizes, such as A4 and B5. In other words, the user can select the non-standard paper size to set a size from the communication application 200 and issue a print instruction. In response to the user selecting any item in the paper size options 410, the screen shifts, and the print setting screen 404 in which the setting value selected in the paper size options 410 is reflected is displayed. Here, the size of the user set paper has been set in advance in the target printer (the communication apparatus 151). The user operates an operation unit or the like of the target printer (the communication apparatus 151) in advance to register a value of the size of the user set paper or the like in the target printer (the communication apparatus 151). Then, in a case where the target printer (the communication apparatus 151) receives a print job in which the user set paper is set as the paper size from the communication application 200, the target printer performs printing on paper of the predetermined size. The communication application 200 may be configured to enable a user to set the size of the user set paper. For example, the communication application 200 receives a numerical input of the size from the user. In this case, a print job including information about the size of the user set paper set on the communication application 200 is transmitted to the target printer (the communication apparatus 151), and the target printer (the communication apparatus 151) performs printing on paper of the size based on the information.

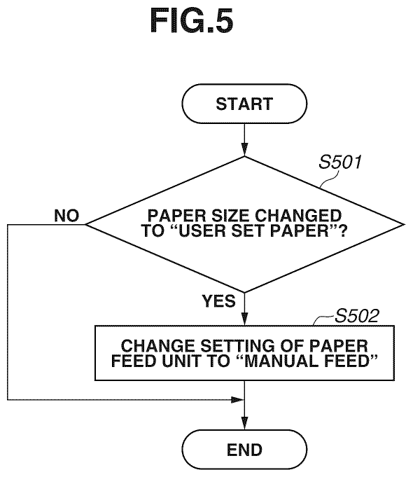

FIG. 5 is a flowchart illustrating changing the setting of the paper feed unit that is performed by the communication application 200 according to the present embodiment. Processing in the present flowchart is realized by the CPU 103 reading various programs stored in a memory such as the external storage device 106 to the RAM 105 and executing them. Specifically, the processing in the present flowchart is realized by executing the communication application 200 and particularly corresponds to processing by the display control unit 202 and the print control unit 204.

In step S501, the communication application 200 detects that the paper size is specified on the output paper size selection screen 409 and determines whether the specified paper size is the user set paper. In a case where the communication application 200 determines that the specified paper size is the user set paper (YES in step S501), the processing proceeds to step S502. In a case where the communication application 200 determines that the specified paper size is not the user set paper (NO in step S501), the already available processing is performed, and the processing in the present flowchart is terminated. In step S502, the communication application 200 changes the setting of the paper feed unit in the print setting to manual feed. With this change, the setting of the paper feed unit for the print job generated by selection of the print button 403 is set to manual feed. In the communication application 200, the default setting, namely, an initial state of the setting of the paper feed unit, is “automatic”.

In a case where the user sets the paper size to the non-standard size “user set paper” in the communication application 200 by the processing in the FIG. 5 flowchart, the setting of the paper feed unit is automatically changed to “manual feed” without the user performing an operation to change the setting of the paper feed unit, whereby the number of operations performed by the user is reduced. Generally, users often set paper of the “user set paper” size in a manual paper feed unit to perform printing, so that usability may be improved by automatically changing the setting of the paper feed unit to “manual feed”. While, in the present embodiment, “user set paper” is described as an example of a paper size for which the setting of the paper feed unit is automatically changed, other paper sizes may be used as long as they are non-standard paper sizes. While an example is described in which the setting of the paper feed unit is set to manual feed for “user set paper”, the paper feed unit may be automatically set to a predetermined cassette (paper feed stage).

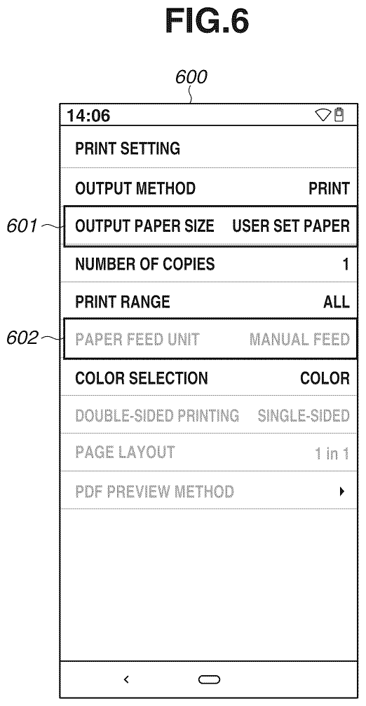

FIG. 6 is a diagram illustrating a display example of print settings of the communication application 200. A print setting screen 600 is displayed in a case where the paper size is set to the user set paper and the paper feed unit is set to manual feed by the processing in steps S501 and S502 in the flowchart in FIG. 5. Compared with the print setting screen 404, an output paper size item 601 is changed to the user set paper, and a paper feed unit item 602 is changed to manual feed. A display item in the paper feed unit item 602 is grayed out so that the user cannot change the automatically changed setting value again. While, according to the present embodiment, the automatically changed item cannot be changed again by the user, it may be configured in such a manner that the automatically changed item is enabled to be changed again. If the user shifts the print setting screen 600 to the print preview screen 400 and selects the print button 403, a print job in which the paper size is set to the user set paper and the paper feed unit is set to manual feed is transmitted from the communication application 200.

As described above, according to the present embodiment, the user set paper is added to the paper size option, and the paper feed unit is automatically changed to the manual feed tray in a case where the user set paper is specified, which reduces a mistake in the setting of the paper feed unit and the number of user interface (UI) operations and prevents a mistake in printing using the user set paper.

According to the first embodiment, an example has been described in which the setting of the paper feed unit is changed in response to specifying the user set paper. However, in some instances, it may be better to change the print setting other than the paper feed unit in using the user set paper. For example, in a case where the user set paper is small paper, double-sided printing is inexecutable for the small paper, so that it may be better to set a double-sided/single-sided setting to single-sided. Such a change in the print setting is described below in a second embodiment. The basic configuration of the second embodiment is the same as that of the first embodiment, as such, only differences will be described.

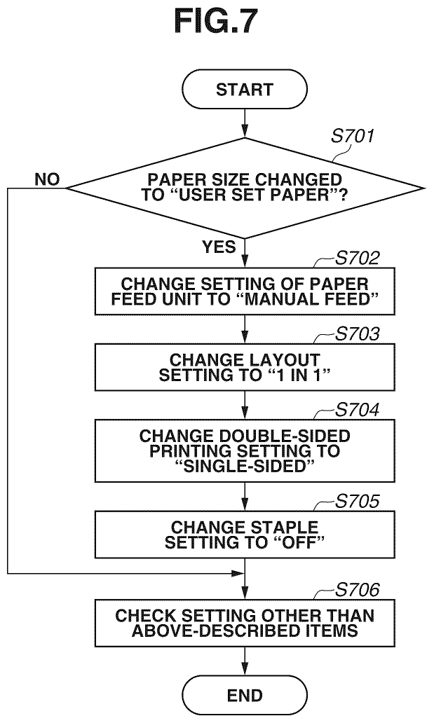

FIG. 7 is a flowchart illustrating changing the print setting in a case where the paper size is changed to the user set paper in the communication application 200 according to the second embodiment. Processing in the present flowchart is realized by the CPU 103 reading various programs stored in a memory, such as the external storage device 106, to the RAM 105 and executing them. Specifically, the processing in the present flowchart is realized by executing the communication application 200 and particularly corresponds to processing that is performed by the display control unit 202 and the print control unit 204.

In step S701, the communication application 200 detects that the paper size is specified on the output paper size selection screen 409 and determines whether the specified paper size is the user set paper. In a case where the communication application 200 determines that the specified paper size is the user set paper (YES in step S701), the processing proceeds to step S702. In a case where the communication application 200 determines that the specified paper size is not the user set paper (NO in step S701), the processing proceeds to step S706, and the communication application 200 checks whether there is a conflict or an inconsistency in the print setting set by the user.

In step S702, the communication application 200 changes the setting of the paper feed unit to manual feed. With this change, the paper feed unit for the print job generated by selection of the print button 403 is set to manual feed.

In step S703, the communication application 200 changes a setting of a document (page) layout to 1 in 1. With this change, the print job generated by selection of the print button 403 is set to 1 in 1. In step S704, the communication application 200 changes the double-sided/single-sided setting to single-sided. With this change, the print job generated by pressing the print button 403 is set to single-sided printing. This setting change is performed since double-sided printing may be inexecutable if the user set paper is small. In step S705, the communication application 200 changes a staple setting to off, i.e., no stapling. With this change, the staple setting of the print job generated by selection of the print button 403 is set to off. When the user uses the user set paper as the paper size, the settings, such as 1 in 1, single-sided, and no stapling, are often used, so that in a case where the user sets the user set paper as the paper size, these settings are automatically changed, which can reduce the number of operations performed by the user. Then, in step S706, the communication application 200 checks whether there is any defect in the setting performed by the user and the automatically changed print setting and terminates the processing.

By performing the above-described processing, in addition to the setting of the paper feed unit described according to the first embodiment, it is possible to eliminate a print setting that may cause a conflict or a setting error and automatically change a setting to one that enables correct printing in a case where printing is performed on the user set paper. The processing for setting 1 in 1, single-sided, and stapling in steps S703 to S705 does not need to be performed in any particular order. Here, an example of changing the paper feed unit, layout, double-sided/single-sided, and staple settings is described. Other settings may be changed, where at least one or more items may be changed in the above-described setting items. In a case where the print setting is automatically changed, a screen may be displayed so that the user can recognize the change of the setting. For example, the changed setting value may be highlighted, or a pop-up message may be displayed to notify the user of the change in the setting value.

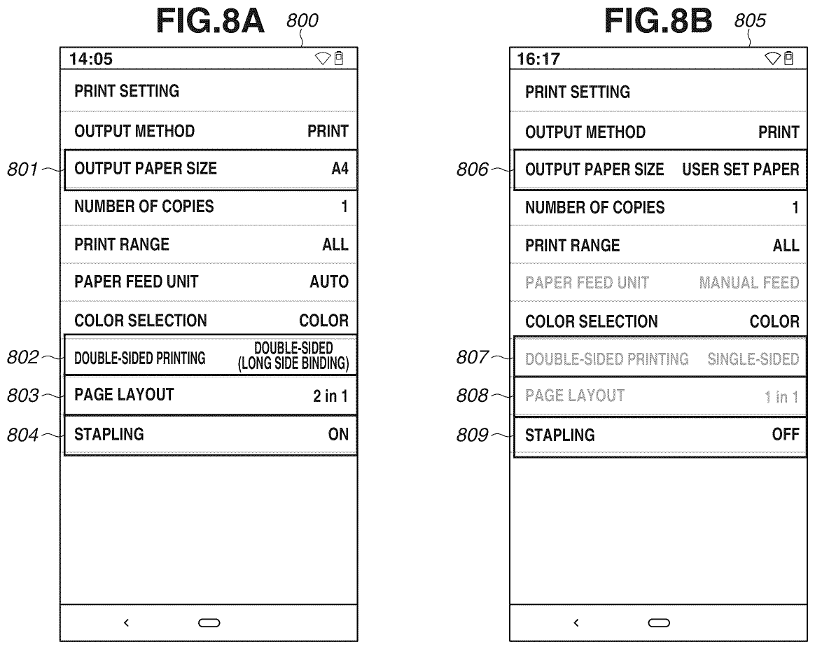

FIGS. 8A and 8B are diagrams illustrating display examples of print settings of the communication application. A print setting screen 800 is a screen displayed before the processing in the flowchart in FIG. 7 is started, and a print setting screen 805 is a screen displayed after the processing in the flowchart in FIG. 7 is terminated. The output paper size is changed from an item 801 (A4) to an item 806 (user set paper) by the processing in step S702. The page layout is changed from an item 803 (2 in 1) to an item 808 (1 in 1) by the processing in step S703. The double-sided/single-sided setting is changed from an item 802 (double-sided) to an item 807 (single-sided) by the processing in step S704. The staple setting is changed from an item 804 (ON) to an item 809 (OFF) by the processing in step S705. The automatically changed setting may be displayed in a grayed-out state so that the user cannot change it, or the setting may be configured to be changeable by the user.

Not only on a print setting screen, but also on a print preview screen, there is a function that cannot be executed due to the change of the paper size to the non-standard size. Specifically, it becomes impossible to display a preview image and to execute a function of requesting the cloud to convert image data. Since the paper size is the non-standard size, processing of the functions becomes complicated, so that execution of these functions is disabled in the first place.

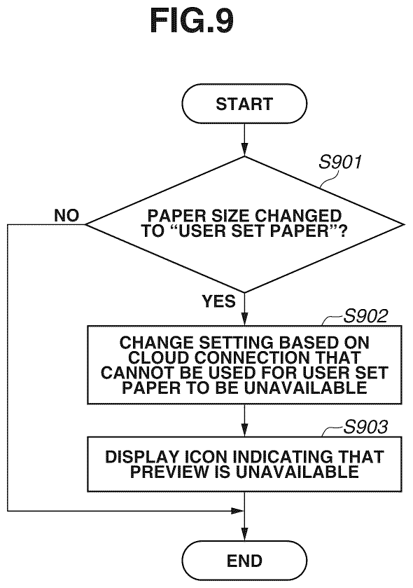

FIG. 9 is a flowchart illustrating processing that is to change a function to unavailable in a case where the paper size is changed to the user set paper, and is performed by the communication application 200 according to the present embodiment. Processing in the present flowchart is realized by the CPU 103 reading various programs stored in a memory, such as the external storage device 106, to the RAM 105 and executing them. Specifically, the processing in the present flowchart is realized by executing the communication application 200. Particularly, the processing corresponds to processing by the display control unit 202 and the print control unit 204.

In step S901, the communication application 200 detects that the paper size is specified on the output paper size selection screen 409 and determines whether the specified paper size is the user set paper. In a case where the communication application 200 determines that the specified paper size is the user set paper (YES in step S901), the processing proceeds to step S902. In a case where the communication application 200 determines that the specified paper size is not the user set paper (NO in step S901), the processing is terminated. In step S902, the communication application 200 sets the function that is not able to be used for the user set paper to be unavailable. In the present embodiment, a cloud conversion function of converting image data into an image in the cloud is set to be unavailable. The cloud conversion function is, for example, a function in which the communication application 200 transmits a file to the cloud and acquires and displays a preview image converted by the cloud. The cloud conversion function includes a function in which the communication application 200 transmits a file to the cloud and transmits image data converted in the cloud to the printer. In the present embodiment, it is considered that these cloud conversion functions are inexecutable in the setting of the user set paper. In step S903, the communication application 200 changes the display of the preview image illustrated as the print preview image 401 in FIG. 4A to an icon for a case where a preview is not able to be generated. These changes are made since the cloud conversion function cannot be used in step S902 and a preview image is not able to be acquired.

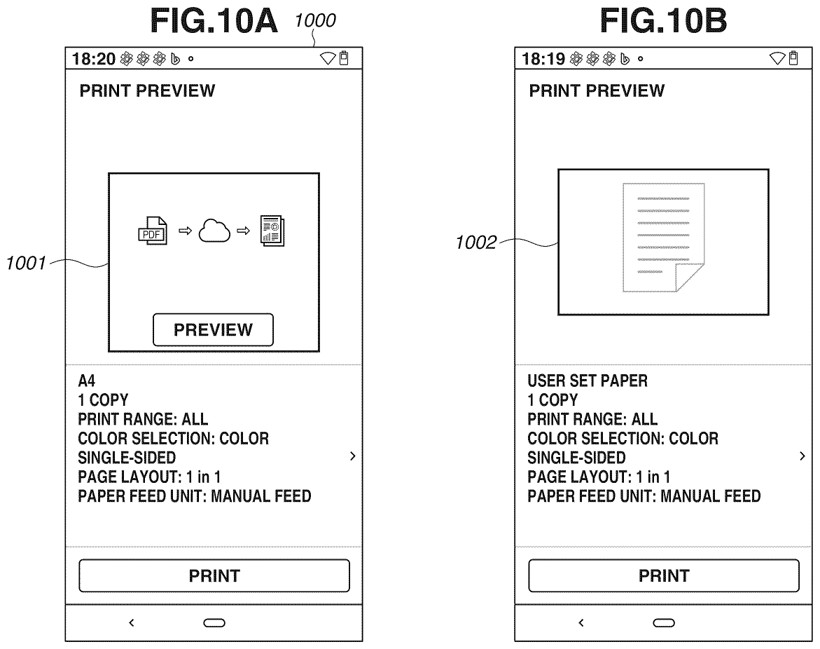

FIGS. 10A and 10B are diagrams each illustrating a display example of a print preview screen of the communication application 200. A preview 1001 on a print preview screen 1000 is an area where a preview of an image to be printed is displayed like the print preview image 401. Depending on an image or a file to be printed, a preview image may not be able to be displayed. In such a case, a button for acquiring a preview using the cloud conversion function is displayed like the preview 1001. In a case where the button is selected, the communication application 200 communicates with the cloud and is able to acquire a preview image.

In a case where the print setting is the user set paper, the cloud conversion function cannot be used, and a preview image cannot be acquired. Thus, the communication application 200 displays a preview 1002 by the processing in the flowchart in FIG. 9. The preview 1002 is an example in a case where the preview 1001 is changed to the icon that is displayed in a case where a preview is not able to be generated in step S903. The preview 1002 does not include the button for acquiring a preview that is included in the preview 1001. A message may be displayed indicating that the cloud conversion function is not able to be used because the user set paper is set. Even in a case where a preview image is able to be displayed without using the cloud conversion function, in other words, in a case where a print file for which a print preview image is able to be displayed without using the cloud conversion function is selected, a preview image may be hidden in a case where the user set paper is set in the print setting.

As described above, according to the present embodiment, a user can properly recognize a function that is not able to be used due to use of the user set paper.

According to the first and second embodiments, the change in the print setting for correctly performing printing using the user set paper is described. According to a third embodiment, an example is described in which a content of a print job is changed based on a printing method in a case where the user set paper is set.

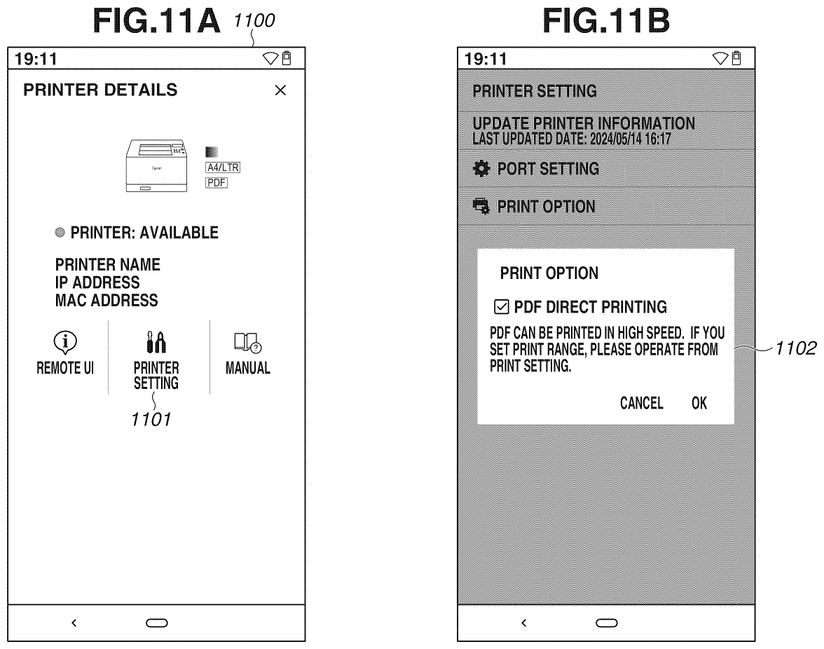

FIGS. 11A and 11B are diagram each illustrating a display example of a printer details screen of the communication application 200. A printer details screen 1100 indicates information about a target printer to which the communication application 200 may issue a print instruction. A user can see an icon indicating a printer state, a printer name, an IP address, and the like. The printer details screen 1100 may also include a link to a manual. A printer setting button 1101 may change the printer setting. A print option screen 1102 in FIG. 11B is displayed in response to selection of the printer setting button 1101. On the print option screen 1102, the printing method of the printer is selectable. In the present embodiment, a method for directly transmitting a Portable Document Format (PDF) file to the printer and printing the PDF file is referred to as a PDF direct printing method. A method for transmitting an image rendered by the communication application 200 to the printer and printing the image is referred to as an image printing method. Since PDF direct printing is checked on the print option screen 1102, printing is to be performed using the PDF direct printing method. In a case where the check is removed, the method is switched to the image printing method.

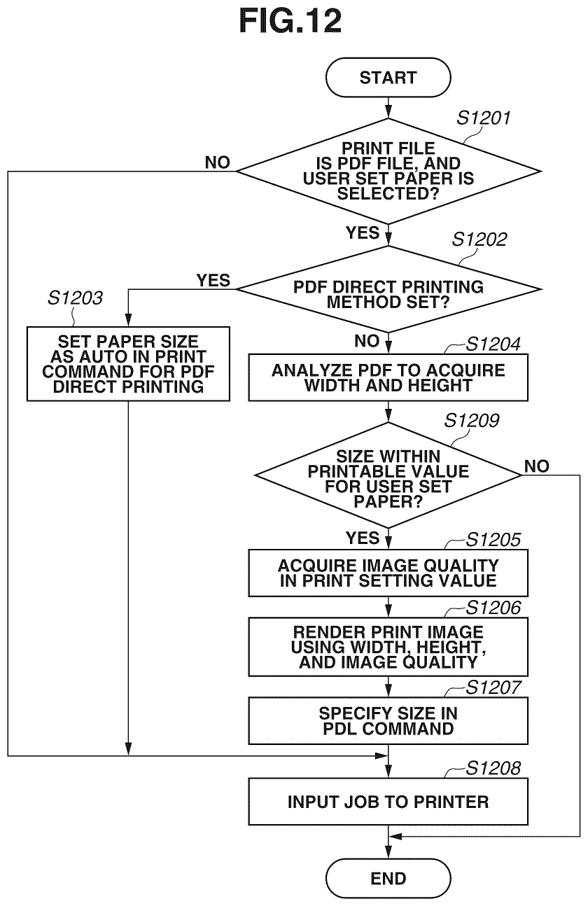

FIG. 12 is a flowchart illustrating processing that is to change a content of a print job in accordance with the printing method and presence or absence of the setting of the user set paper and is performed by the communication application 200 according to the present embodiment.

Processing in the present flowchart is realized by the CPU 103 reading various programs stored in a memory, such as the external storage device 106, to the RAM 105 and executing them. Specifically, the processing in the present flowchart is realized by executing the communication application 200. Particularly, the processing corresponds to processing by the display control unit 202 and the print control unit 204.

According to the present embodiment, a case where there are two types of methods, that is, the PDF direct printing method and the image printing method is described as an example. The processing in the present flowchart is started when, for example, a user selects a print file and then sets the paper size.

In step S1201, the communication application 200 determines whether the print file specified by the user is a PDF file and the paper size is the user set paper. The PDF direct printing method is a method that is usable only for a PDF file. In a case where the print file is a PDF file and the paper size is the user set paper (YES in step S1201), the processing proceeds to step S1202. In a case where the determination is no (NO in step S1201), the processing is the same as the conventional processing, so that the processing proceeds to step S1208 and is terminated.

In step S1202, the communication application 200 determines whether the PDF direct printing method is set to the application. This determination is performed based on the setting performed by the user on the print option screen 1102 in FIG. 11B. In a case where the PDF direct printing method is set (YES in step S1202), the processing proceeds to step S1203. In a case where the PDF direct printing method is not set (NO in step S1202), the processing proceeds to step S1204. When the PDF direct printing method is not set, the method set in the application is the image printing method.

In step S1203, the communication application 200 specifies Auto as the paper size in a print command. In the PDF direct printing method, a print target PDF file and a print setting command for printing are transmitted together to the printer. In the processing, in a case where the user set paper is set, there is no need to specify the paper size, and it is sufficient to specify Auto that enables the printer to automatically determine the paper size to be used for printing. Then, the processing proceeds to step S1208, the communication application 200 transmits the print job to the printer by the PDF direct printing method, and the processing in the flowchart is terminated.

In step S1202, in a case where the image printing method is set instead of the PDF direct printing method (NO in step S1202), in step S1204, the communication application 200 analyzes the PDF file to acquire sizes of horizontal and vertical widths. A library provided in the OS or a PDF analysis library may be used to analyze the PDF file.

Next, in step S1209, the communication application 200 determines whether the horizontal and vertical widths acquired in step S1204 are printable values of the user set paper. In a case where the size of the user set paper is too small or too long, the printer cannot perform printing. Thus, printable values are set as limit values. The printable values typically vary between printers, but are usually similar.

According to the present embodiment, the communication application 200 stores these values as defined values and compares setting vales with these values, but the printable values may be acquired from the printer to be used. In a case where the acquired horizontal and vertical widths are within the printable values of the user set paper (YES in step S1209), the processing proceeds to step S1205. In a case where the acquired horizontal and vertical widths exceed the printable values (NO in step S1209), the print instruction is not able to be issued, and thus the processing in the flowchart is terminated. In this processing, the user may be notified of the error and a reason for the error.

In step S1205, the communication application 200 acquires a print image quality. The print image quality (resolution) is a value set in the communication application 200, and may include a plurality of values, such as a high image quality 600 dpi, a normal image quality 300 dpi, and a low image quality 96 dpi, or may be a value specified by the user. In step S1206, the communication application 200 renders a print image using the horizontal and vertical widths acquired in step S1204 and the image quality acquired in step S1205. Generally, a print size is calculated by dividing a pixel size of the print image by the resolution and multiplying by 25.4 (pixel size of the print image/resolution * 25.4=print size). The pixel size of the print image can be calculated backwards from the horizontal and vertical widths acquired in step S1204. In the present embodiment, the PDF file is printed at the same size, but a magnification may be factored in for enlargement or reduction. Next, in step S1207, the communication application 200 specifies the calculated pixel size in a page description language (PDL) command. PDL is a page description language that the printer can interpret. Then, the processing proceeds to step S1208, the communication application 200 transmits the print job to the printer by the image printing method, and the processing in the flowchart is terminated.

In the above-described processing, the communication application 200 changes the content of the print job in generating the print job for the user set paper based on whether the PDF direct printing method or the image printing method is used.

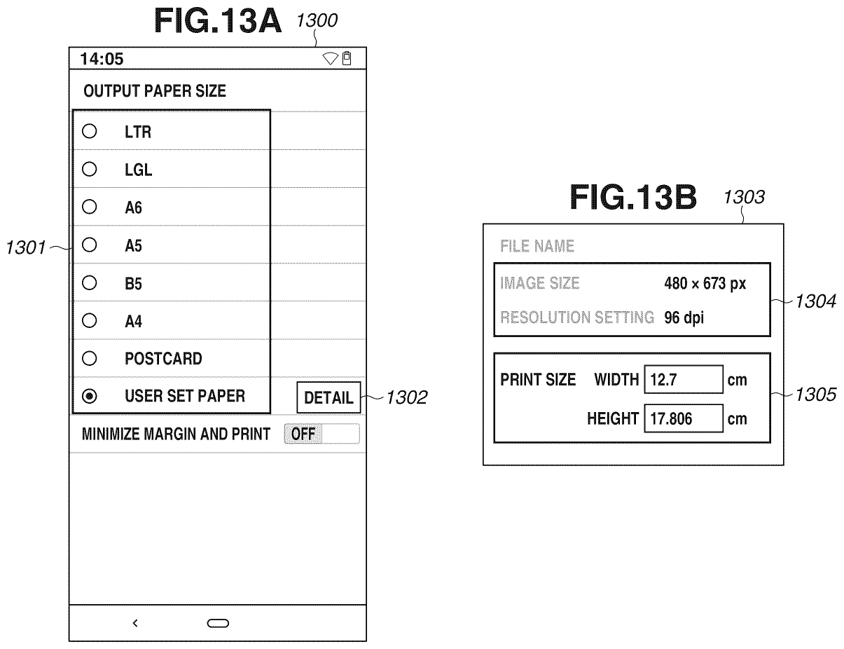

FIGS. 13A and 13B are diagrams each illustrating a display example of print settings of the communication application 200. An output paper size selection screen 1300 displays selectable paper sizes. Paper size options 1301 display and enable selection of the user set paper in addition to the standard paper sizes. A user set paper detail button 1302 is provided where, in response to selection of the user set paper detail button 1302, a detail paper size 1303 is displayed. In the detail paper size 1303, the print size and the resolution acquired by the processing in the flowchart in FIG. 12 are displayed. The detail paper size 1303 is displayed so that the user can understand the size of the user set paper and check whether the size of the user set paper is not different from the paper to be set in the printer. The detail paper size 1303 may be configured to display an image size and resolution in an area 1304, display the print size in an area 1305, and receive a change in the size from a user.

According to the present embodiment, it is possible to appropriately generate and transmit a print job for the user set paper regardless of whether the PDF direct printing method or the image printing method is used.

The above-described first to third embodiments may be configured in combination with one or more of each other. The present disclosure can also be realized by software (a program) for realizing the functions of the above-described embodiments being supplied to a system or an apparatus via a network or various storage media, and a computer (or CPU or micro processing unit (MPU)) of the system or the apparatus reading and executing the program. In this case, the computer program and the storage media storing the computer program constitutes the present disclosure.

According to the present disclosure a setting is suitably performed even in a case where an instruction to perform printing is issued from a terminal to an image processing apparatus.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™(BD)), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-106232, filed Jul. 1, 2024, which is hereby incorporated by reference herein in its entirety.

What is claimed is:

1. A method for controlling an information processing apparatus including a predetermined program, the method comprising:
receiving a non-standard size setting as a paper size of a print setting on a screen that is displayed by the predetermined program;
automatically changing a setting of a paper feed unit to manual feed by the predetermined program based on receipt of the non-standard size setting without receiving a user operation for changing the setting of the paper feed unit in the print setting on a screen that is displayed by the predetermined program; and
controlling transmission of a print job based on the print setting to an image processing apparatus by the predetermined program.

2. The method according to claim 1, wherein, a double-sided/single-sided setting is automatically changed to single-sided by the predetermined program based on receipt of the non-standard size setting without receiving a user operation for changing the double-sided/single-sided setting in the print setting on a screen that is displayed by the predetermined program.

3. The method according to claim 1, wherein, a layout setting is automatically changed to 1 in 1 by the predetermined program based on receipt of the non-standard size setting without receiving a user operation for changing the layout setting in the print setting on a screen that is displayed by the predetermined program.

4. The method according to claim 1, wherein, a staple setting is automatically changed to no stapling by the predetermined program based on receipt of the non-standard size setting without receiving a user operation for changing the staple setting in the print setting on a screen that is displayed by the predetermined program.

5. The method according to claim 1, wherein a user is prevented from changing the setting of the paper feed unit.

6. The method according to claim 5, wherein, a setting item of the paper feed unit is displayed such that changing of the setting item by a user is disabled.

7. The method according to claim 1, wherein a value of the non-standard size is set by a user.

8. The method according to claim 1, further comprising displaying a paper size setting screen including an item indicating a standard size and an item indicating a non-standard size as paper sizes of the print setting.

9. The method according to claim 1, wherein the standard size is at least one of A4 or B5.

10. The method according to claim 1, wherein, in a case where the non-standard size setting is received, a print preview image is not displayed.

11. The method according to claim 1, wherein, in a case where the non-standard size setting is received, a display item via which image conversion is requested to a cloud service is not displayed.

12. The method according to claim 1, wherein transmission of the print job includes directly transmitting a Portable Document Format file to the image processing apparatus and transmitting rendered data to the image processing apparatus, wherein when the non-standard size setting is received, a content of the print job to be transmitted is changed.

13. The method according to claim 1, further comprising displaying an image size and a print size of a file to be printed.

14. The control method according to claim 1, wherein the predetermined program is an application program.

15. A non-transitory computer-readable storage medium storing a program that causes a computer of an information processing apparatus including a predetermined program to execute a method, the method comprising:
receiving a non-standard size setting as a paper size of a print setting on a screen that is displayed by the predetermined program;
automatically changing a setting of a paper feed unit to manual feed by the predetermined program based on receipt of the non-standard size setting without receiving a user operation for changing the setting of the paper feed unit in the print setting on a screen that is displayed by the predetermined program; and
controlling transmission of a print job based on the print setting to an image processing apparatus by the predetermined program.

16. An information processing apparatus including a predetermined program, the information processing apparatus comprising:
a memory storing instructions; and
a processor, that when executing the instructions, causes the information processing apparatus to:
receive a non-standard size setting as a paper size of a print setting on the;
automatically change a setting of a paper feed unit to manual feed by the predetermined program based on receipt of the non-standard size setting without receiving a user operation for changing the setting of the paper feed unit in the print setting on a screen that is displayed by the predetermined program; and
controlling transmission of a print job based on the print setting to an image processing apparatus by the predetermined program.
